(19) United States
(12) Patent Application Publication
(10) Pub. No.: US 2010/0313018 A1
(43) Pub. Date: Dec. 9, 2010

(54) METHOD AND SYSTEM FOR BACKUP AND RESTORATION OF COMPUTER AND USER INFORMATION

(75) Inventor: Michael Jörgensen, Ramlosa (SE)

Correspondence Address: VOLPE AND KOENIG, P.C., UNITED PLAZA, 30 SOUTH 17TH STREET, PHILADELPHIA, PA, 19103, US

(73) Assignee: SREG INTERNATIONAL AB, Helsingborg (SE)

(21) Appl. No.: 12/679,127

(22) PCT Filed: Sep. 22, 2008
(86) PCT No.: PCT/SE2008/051058

§ 371 Date: Jul. 29, 2010

Related U.S. Application Data
(60) Provisional application No. 60/974,862, filed on Sep. 25, 2007.

(30) Foreign Application Priority Data
Sep. 21, 2007 (SE) 0702106-6

(51) Int. Cl. H04L 9/32; G06F 15/16

(52) U.S. Cl. 713/168

(57) ABSTRACT

A method for performing backup of computer specific information from a computer is disclosed. The method includes receiving, at a remote server, user authentication data obtainable from a user of the computer; in response to a positive authentication based on the user authentication data, the remote server establishing a communication channel between the computer and the remote server; authenticating, via the communication channel, the computer for use with the server; sending, via the communication channel, a computer specific information collect request from the server to the computer; collecting computer specific information at the computer; encrypting the computer specific information; and sending, via the communication channel, the encrypted computer specific information to the remote server.

### TECHNICAL FIELD

The invention relates to a method and a system for backup and restoration of computer and user information. More specifically the invention relates to a method and system for enabling safe online storage and online retrieval of computer specific information.

### BACKGROUND OF THE INVENTION

Today, computers are used to store important personal and business related information. Computers connected to the Internet allows users to connect to online banking services or shop online. Further, media files are often provided with DRM protection to ensure that the content only can be played back on the computer or system it was originally downloaded to. To take advantage of these services the computers store account information, passwords, electronic certificates, encryption keys as well as system settings etc.

To meet the increased need for secure methods for handling data and providing identification means for different kinds of online services a Trusted Platform Module (TPM) has been developed. A TPM is a hardware chip enabling unique encryption key generation, remote attestation and data sealing etc.

In case of hardware failure or theft, there is a very real risk of loosing the important data thus loosing access to encrypted data, certificates used for identification for online services and other computer specific information. In order to minimize loss of data in case of e.g. hardware failure or theft it is therefore crucial to perform regular backups of the computer specific information. Backup solutions of today often use external media such as USB-harddrives, CD-R, CD-RW, DVD-R or DVD-RW etc to store the backed up data. Often, however, the backup copies are stored in close proximity of the computer thus still risking the backup copies to be stolen or be lost together with the computer for instance in the case of a fire. Further, for restoring the backuped information to a computer the location of the backup medias must be known, and if the computer is to be restored to a configuration of a specific time (i.e. in case a plurality of different back ups exist), the right copy corresponding to that specific time must be located. Thus, what is needed is a more convenient and secure method of backing up and restoring computer specific information.

Online backup services exist which allow backups to be sent to remote servers, thus providing off-site storage space for computer data.

However, the type of computer specific information discussed above are of especially sensitive content. Thus sending these backups over the Internet is not very safe because of the risk of a malicious third party stealing the information. Using different hacking methods such as pharming, a malicious third party could potentially redirect the backup from a legitimate server to a false server thus stealing the information without the user ever noticing. Potentially, a target computer could be compromised to send the backup data into the wrong hands.

Thus, there is a need for an improved and secure method for performing backups and restorations of sensitive data.

For corporations or individuals having several computers there is also a need for a backup and restore method allowing centralized performed simultaneous backup of all computers on a network.

### SUMMARY OF THE INVENTION

Thus, one object of the present invention is to provide an improved method for backing up important computer specific information from a computer.

A further object of the present invention is to provide an improved method for restoring computer specific information to a computer.

The objects of the invention are achieved by an improved backup method in accordance with claim 1 and an improved restoring method in accordance with claim 10. Alternative embodiments are presented in the dependent claims.

Specifically, the present invention is a method for performing backup of computer specific information from a computer, the method comprising: receiving, at a remote server, user authentication data obtainable from a user of the computer; in response to a positive authentication based on said user authentication data, the remote server establishing a communication channel between said computer and the remote server; authenticating, via said communication channel, said computer for use with said server; sending, via said communication channel, a computer specific information collect request from said server to said computer; collecting computer specific information at said computer; encrypting said computer specific information; and sending, via said communication channel, said encrypted computer specific information to the remote server.

Requiring both the user of the backup service provided by the server and the computer that is to be backed up to the service server to be authenticated provides an extra level of security as compared to the prior art.

The computer can be authenticated using information provided during registration of the computer for use with the service. The information may include IP-address of the computer, MAC-address, network port to use with the service etc.

The fact that the server sends a backup initiation request to the computer further increases the security since interfering with the backup process would involve infiltrating (or “hacking”) the remote server. This would be much more difficult than infiltrating (or “hacking”) a single user computer. Finally, encrypting the computer specific information before it is sent over the communication channel renders eaves dropping of the information by a malicious third party much more difficult.

Further, having the server establishing a communication channel to the computer and initiating a backup request to the same admits starting backups of computer specific information of a plurality of computers simultaneously from any device authenticated for connecting to and using the backup service server.

After the computer specific information backup has been received by the server, the server may also send an acknowledgement to the user.

According to one embodiment, the computer requests a confirmation from the user in response to the computer specific information collect request.

Further, the confirmation may be encrypted by means of a private encryption key. Throughout this text reference is made to “private” keys and “public” keys. This reference relate to so-called “public-key cryptography”, also known as asymmetric cryptography. In this type of cryptography a user is provided with a pair of keys, a public key and a private key. The private key is kept secret with the user, while the public key is made available to the public (via e.g. the Internet). Both keys are mathematically related, but the public key provides no (practically) information in respect of the private key. A message encrypted with the public key can be decrypted only with the corresponding private key (and not with the public key).

The above confirmation can be performed by having the user sending a specific message encrypted with his private key, and the computer decrypting the message with a corresponding public key. Since the private key of the user is unique a successfully decrypted message guarantees the identity of the user.

By this precautionary step, the backup process is guaranteed to start only if a properly authenticated user confirms the backup request. This increases the security of the method by making it more difficult for a malicious third party to steal sensitive computer specific information by requesting backup from a computer without the knowledge of the user.

The authenticating of the computer for use with said server may be accomplished in a similar way by having the computer sending a message encrypted with a private key and having the remote server decrypting the message with a corresponding public key.

According to one embodiment the computer authenticates the remote server. This may be accomplished for example by having the server sending a message encrypted with a private key and the computer decrypting the message with a corresponding public key.

This step guarantees the identity of the server if the private key is known only to the server and possibly to the user and thereby avoids sending the backup to a malicious third party.

The private keys are preferably generated when a user registers for connecting to the server and using the backup and restore service. The service generates a private and public key pair by methods known in the art and distributes the pair to the user. The key pair can also be distributed to the computers that are authenticated for use with the server. The server keeps a copy of the public key and optionally also the private key. The server can use these keys for identifying a computer or a user. The keys can also be used for identifying itself towards a computer or user.

The collecting and encrypting of the user data may be performed in an internal memory of said computer. The internal memory can be a solid state memory or any type of volatile memory.

After the computer specific information has been sent to the remote server it is deleted from the internal memory.

This is done to ensure that no traces of sensitive computer specific information are left in memory after the backup is finished.

The invention also provides a secure method for restoring backed up computer specific information to a computer, the method comprising: receiving, at a remote server, user authentication data obtainable from a user of the computer; in response to a positive authentication based on said user authentication data, the remote server establishing a communication channel between said computer and the remote server; authenticating, via said communication channel, said computer for use with said server; sending, via said communication channel, a computer specific information restore initiation request from said server to said computer; sending, via said communication channel, encrypted computer specific information to said computer; decrypting said computer specific information at said computer; and restoring said computer specific information to said computer.

Requiring both user and computer authentication provides an extra level of security as compared to the prior art since authenticating the computer for use with the remote server ensures that only the correct computer will receive the computer specific information.

The computer can be authenticated using information provided during registration of the computer for use with the service. The information may include IP-address of the computer, MAC-address, network port to use with the service etc.

The fact that the server sends a restore initiation request to the computer further increases the security since interfering with the restore process would involve infiltrating (or “hacking”) the remote server. This would be much more difficult than infiltrating (or “hacking”) a single user computer. Finally, encrypting the computer specific information before it is sent over the communication channel renders eaves dropping of the information by a malicious third party much more difficult.

Further this method admits starting restores of computer specific information to a plurality of computers simultaneously from any device authenticated for connecting to and using the restore service server.

The computer may send an acknowledgement to the user when said computer specific information has been received by the computer.

In response to the computer specific information collect request, the computer may request a confirmation from the user.

The confirmation may be encrypted by means of a private encryption key.

This can be performed by having the user sending a specific message encrypted with his private key, and the computer decrypting the message with a corresponding public key as described above. By taking this precautionary step, the backup process is guaranteed to start only if a properly authenticated user confirms the backup request. This increases the security of the method by making it more difficult for a malicious third party to steal sensitive computer specific information by restoring computer specific information to another computer without the knowledge of the user.

The authenticating of said computer for use with the server may comprise the computer sending a message encrypted with a private key and the remote server decrypting the message with a corresponding public key.

According to one embodiment the computer authenticates the remote server. This may be accomplished for example by having the server sending a message encrypted with a private key and the computer decrypting the message with a corresponding public key.

This step guarantees the identity of the server if the private key is known only to the server and possibly to the user. It is thus known that the computer specific information that is restored comes from the correct source, i.e. the remote service server.

The decrypting of the computer specific information may be performed in an internal memory. The internal memory may be a solid state memory or a volatile memory.

The computer specific information is deleted from the internal memory after the computer specific information has been restored to the computer.

This is done to ensure that no traces of sensitive computer specific information are left in memory after the backup is finished.

### DRAWINGS

FIG. 1 illustrates an example of a process of registration of an account for use with the service.

FIG. 2 illustrates an example of a process of activation of an account for use with the server.

FIG. 3 illustrates an example of a process of registration of a computer for use with the server.

FIG. 4 is a flow chart of the backup process of computer specific information from a single computer according to one embodiment of the invention.

FIG. 5 is a flow chart of the backup process of computer specific information from a plurality of computers according to one embodiment of the invention.

FIG. 6 is a flow chart of the restore process of computer specific information to a single computer according to one embodiment of the invention.

FIG. 7 is a flow chart of the restore process of computer specific information to a plurality of computers according to one embodiment of the invention.

### DETAILED DESCRIPTION OF THE EMBODIMENTS

In the following section a detailed description of the embodiments of the invention will be given with reference to the drawings.

The use of the word service corresponds to the backup and/or restore service provided by the remote server and if nothing else is stated these terms will be used interchangeably throughout the rest of the description. The server providing the services can be located on a local area network or the Internet. The service can be used for a single or a plurality of computers. The word user will be used to refer to a user of the backup and restore service provided by a remote server.

All activities relating to the registration, activation and use of the service are performed through a login over an encrypted connection to the remote service server.

The interaction between the user and the service server, i.e. providing customer details, computer information, user authentication data and other interactions, can be provided by different means, e.g. in a form on a user login interface accessed through an Internet browser when connecting to the server or by using an application developed specifically for the backup and restore service.

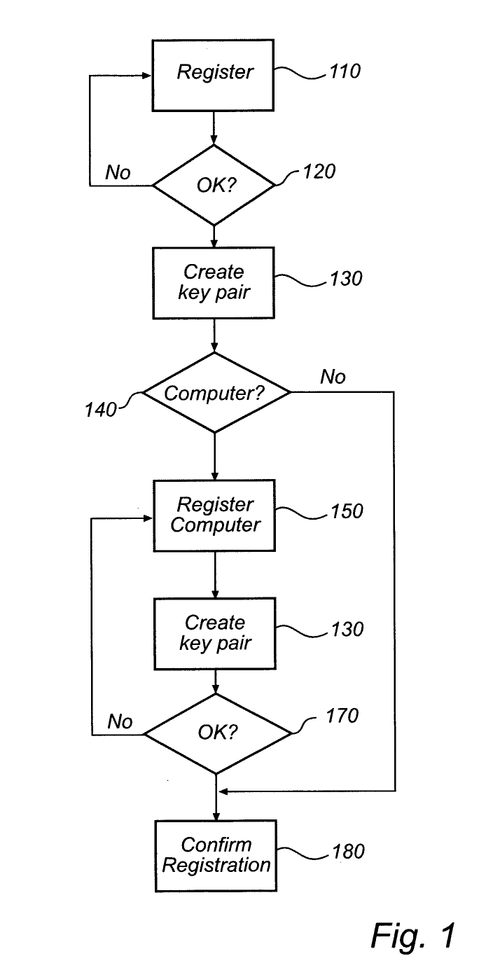

In FIG. 1 an illustrative example of possible process steps for registering accounts for the service are shown. The customer registers for the service by providing customer details 110. Depending on the type of customer (i.e. individual or corporation) different details can be provided. The information is used for identifying a customer or contact person and may include information such as name, company name, address, phone etc. Optionally, the customer can supply an e-mail address that can be used for receiving activation codes and service information.

If all the required details are provided 120 a private-public key pair can be created 130. This key pair can be used to further enhance the security of the service as will be described below.

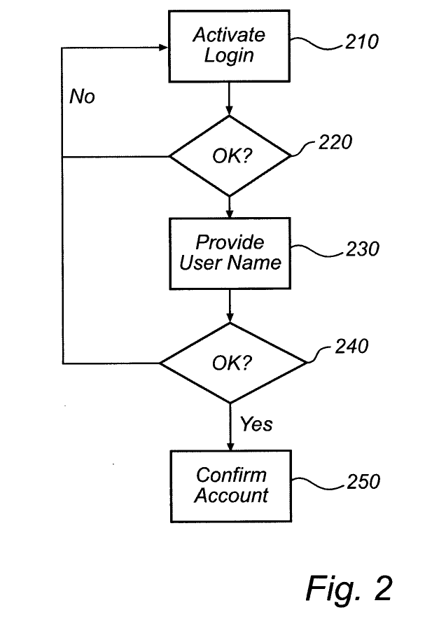

After the customer has registered for the service the customer needs to activate his/her account. The customer receives an activation code to the e-mail address provided during the registration. If no e-mail address was provided the activation code may be sent by other electronic means or by physical mail to the address provided by the customer during the registration process. In FIG. 2 the customer enters the activation page 210 and provides the received activation code. If this code is accepted 220 the user should provide a username and password for use with the service 230.

This username could be an e-mail address however other usernames are also possible. Using an e-mail address provides the advantage that the username can be used for resending forgotten passwords.

If the username is accepted 240, e.g. the e-mail address is not already registered and is fulfilling the criteria of an e-mail address, the user account is confirmed 250.

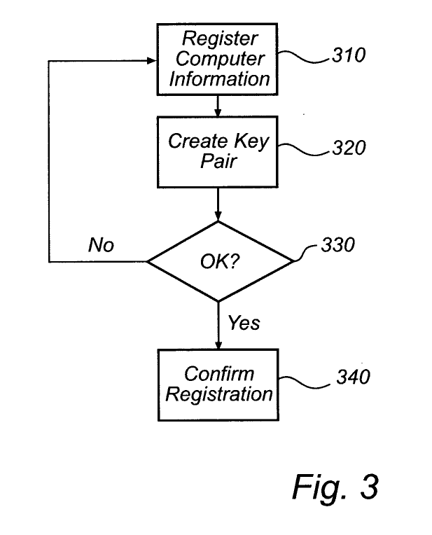

Before a customer can take advantage of the service computers that are to be backuped and restored needs to be registered for the service as shown in FIG. 3. The registration information may include IP-address, MAC-address, network port to use with service etc 310. This information will be used to establish connections between the service server and the computer and also to identify the computer.

Optionally if it not has been generated earlier, a private-public key pair can be generated 320 to enhance the security when performing backups and restores.

When the registration of computers has been accomplished 330 the result of the registration is confirmed and acknowledged to the user 340.

Optionally the registration of the computer may be performed during the account registration phase as illustrated by the steps 150, 160 and 170 in FIG. 1.

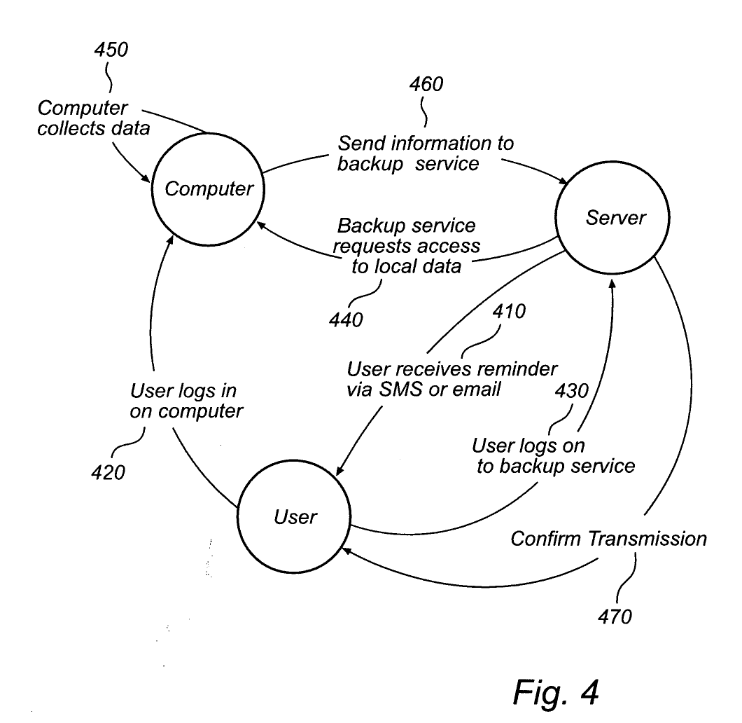

An example embodiment of the backup process according to the invention is illustrated in FIG. 4. A user may be reminded to perform backup of computer specific information by the server through an e-mail, SMS or other electronic message 410.

The backup process starts with the user being logged in on the computer that is to be backed up 420. To start the backup the user logs in on the back up service 430 and send user authentication data to the server. The authentication data may include the user name and password created during the account registration phase. Preferably, the user authentication data is encrypted.

Optionally if a private-public key pair was generated during the registration or activation process, a message encrypted with a private key may be sent to the server which the server decrypts with a corresponding public key upon reception of the message, thus validating the identity of the user.

The user authentication data can be provided by means known to a person skilled in the art, e.g. in a form on a user login interface accessed through an Internet browser when connecting to the server or by using an application developed specifically for the backup and restore service.

In response to a positive user authentication the user gains access to the functions of the service and can from there choose to backup a computer. Alternatively the backup may start automatically.

The server attempts to establish a communication channel to the computer. Preferably, all data sent over this communication channel is encrypted. Once the communication channel is successfully established the computer is required to authenticate itself for use with the server. This can be accomplished by using the information provided during the registration of the computer or using a private-public key pair. Upon successful authentication of the computer the server sends, via the established communication channel, a message to the computer, requesting access to local data 440 and requesting the computer to collect the computer specific information to backup. Upon receiving this request, the computer begins to collect the computer specific information required to be able to fully restore the computer 450. The computer specific information may include both computer hardware/software data and user data such as privileges, encryption keys, certificates, surname, login name, address of the user, or TPM related information such as certificates, encryption keys, etc.

The computer collects and processes the computer specific information locally in an internal memory. The internal memory may for example be a harddrive, a solid state memory or a volatile memory. When the computer specific information has been collected it is encrypted and sent 460 directly through the connection back to the backup service on the server.

After the encrypted computer specific information has been sent, all traces of the computer specific information are deleted from the internal memory of the computer. Thus, no traces of the backup process are left on the computer.

The server and computer may also verify the received computer specific information using methods known to a person skilled in the art, e.g. checksums.

After the backup has been performed a confirmation can be sent 470 to the user. This confirmation can be sent either to the computer that has been backed up or as an email, SMS or other electronic message to the registered user. Also, the event can be logged by the server.

It is possible to allow several generations of backup copies to be stored on the server to make it possible to restore the state of the computer for several different times.

It should be noted that the user is not required to be logged on to the computer that is to be backed up. This can be very convenient if a system administrator needs to backup one or several computers on a network from a central administration computer or any other device authenticated for use with the service.

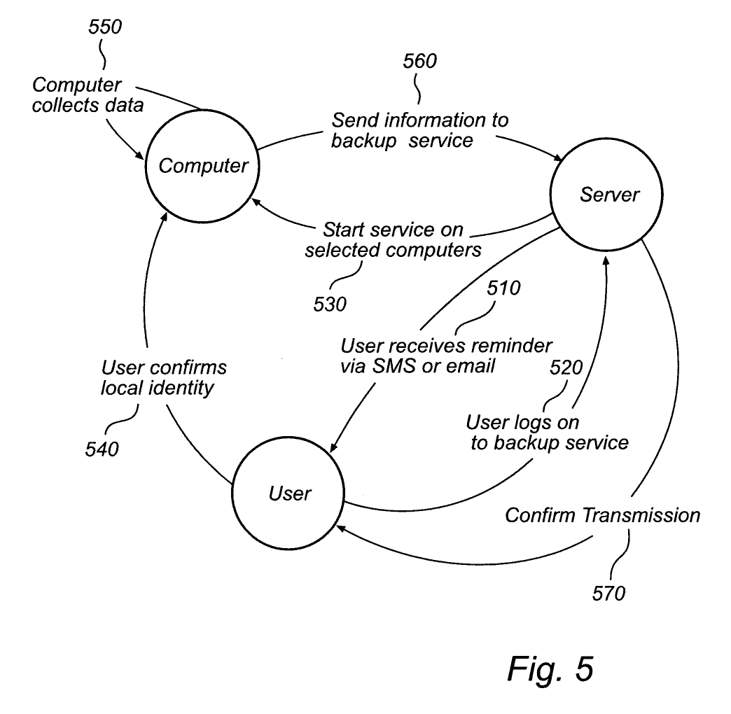

The user can be reminded to perform backup of computer specific information by the server through an SMS or other electronic message 510 as can be seen in FIG. 5.

To start the backup the user logs in on the backup service 520 and sends user authentication data to the server. The authentication data may include the user name and password created during the account registration phase. Preferably, the user authentication data is encrypted.

Optionally if a private-public key pair was generated during the registration or activation process, a message encrypted with a private key may be sent to the server which the server decrypts with a corresponding public key upon reception of the message, thus validating the identity of the user.

The user authentication data can be provided by means known to a person skilled in the art, e.g. in a form on a user login interface accessed through an Internet browser when connecting to the server or by using an application developed specifically for the backup and restore service.

In response to a positive user authentication the user gains access to the functions of the service and can from there choose to backup computers authenticated for use with the server. Alternatively the backup may start automatically.

The server then attempts to establish a communication channel to each computer of the plurality of computers. Preferably, all data sent over the communication channels are encrypted. Once the communication channels are successfully established each computer is required to authenticate itself for use with the server. This can be accomplished by using the information provided during the registration of the computers or using a private-public key pair. Upon successful authentication of the computers, the server sends, via the established communication channels, a message to each computer, requesting a start of the service on the selected computers and requesting the computers to collect the computer specific information to backup 530.

Upon receiving this request, each computer may request a confirmation from the user. Depending on implementation the confirmation may comprise user authentication data for each computer. Alternatively the confirmation may be encrypted by means of a private encryption key. If so, the computer may decrypt the confirmation using a corresponding public key. Upon receiving 540 a confirmation authenticating the user for performing backups of the computer each computer begins to collect 550 the computer specific information required to be able to fully restore privileges, encryption keys, certificates etc.

Each computer collects and processes the computer specific information locally in an internal memory. The internal memory may for example be a harddrive, a solid state memory or a volatile memory. When the user data has been collected it is encrypted. Each computer then sends 560 the computer specific information directly through each respective connection back to the server.

After the encrypted computer specific information has been sent all traces of the computer specific information are deleted from the internal memory of the computers. Thus, no traces of the backup process are left on the computers.

The server and computers may also verify the received computer specific information using methods known to a person skilled in the art, e.g. checksums.

After the backup has been performed, a confirmation can be sent 570 to the user. This confirmation can be sent either to the device used for sending the user authentication data or as a mail, SMS or other electronic message to the registered user. Also, the event can be logged by the server.

It is possible to allow several generations of backup copies to be stored on the server for each computer to make it possible to restore the state of a computer for several different times.

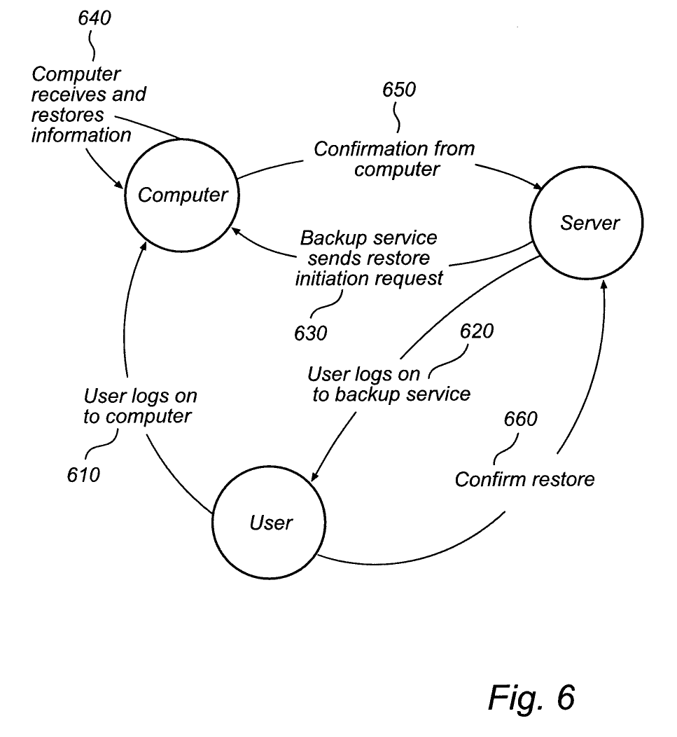

An example embodiment of the backup process according to the invention is illustrated in FIG. 6.

The restore process starts with the user being logged in on the computer that is to be restored 610. To start the restore the user logs on 620 to the backup service and sends user authentication data to the server. The authentication data may include the user name and password created during the account registration phase. Preferably, the user authentication data is encrypted.

Optionally if a private-public key pair was generated during the registration or activation process, a message encrypted with a private key may be sent to the server which the server decrypts with a corresponding public key upon reception of the message, thus validating the identity of the user.

The user authentication data can be provided by means known to a person skilled in the art, e.g. in a form on a user login interface accessed through an Internet browser when connecting to the server or by using an application developed specifically for the backup and restore service.

In response to a positive user authentication the user gains access to the functions of the service and can from there choose to restore computer specific information to a computer. If several generations of backup copies of computer specific confirmation are present on the server, the user may choose which generation to restore. Alternatively the restore may start automatically.

The server attempts to establish a communication channel to the computer. Preferably, all data sent over this communication channel is encrypted. Once the communication channel is successfully established the computer is required to authenticate itself for use with the server. This can be accomplished by using the information provided during the registration of the computer or using a private-public key pair. Upon successful authentication of the computer the server sends 630, via the established communication channel, a restore initiation request to the computer. Upon receiving this request, the computer begins to receive the computer specific information that has been previously backed up 640.

The received backed up computer specific information is preferably encrypted when sent from the server. The computer processes and decrypts the computer specific information locally in an internal memory. The internal memory may for example be a harddrive, a solid state memory or a volatile memory.

After the computer specific information has been restored to its proper location all traces of the computer specific information are deleted from the internal memory of the computer. Thus, no traces of the restore process are left on the computer.

The server and computer may also verify the received computer specific information using methods known to a person skilled in the art, e.g. checksums.

After a successful restore of the computer a confirmation 650 can be sent from the restored computer to the server. The server may confirm that the restore has been performed sending a confirmation 660 to the user. This confirmation can be sent either to the device used for sending the user authentication data or as a mail, SMS or other electronic message to the registered user. Also, the event can be logged by the server.

It should be noted that the user is not required to be logged on to the computer that is to be restored. This can be very convenient if a system administrator needs to restore computer specific information to one or several computers on a network from a central administration computer or any other device authenticated for use with the service.

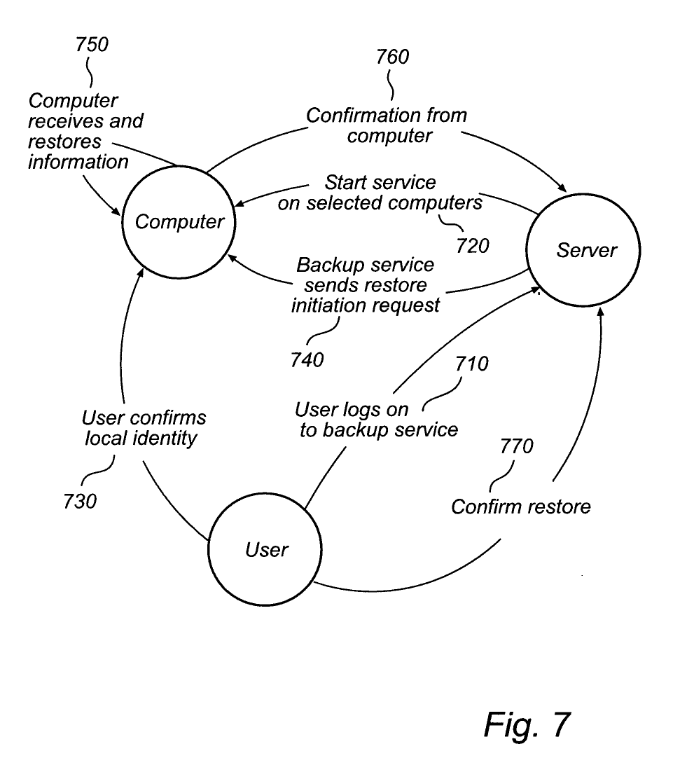

To start the backup the user must send user authentication data to the server 710 as illustrated in FIG. 7. The authentication data may include the user name and password created during the account registration phase. Preferably, the user authentication data is encrypted.

Optionally if a private-public key pair was generated during the registration or activation process, a message encrypted with a private key may be sent to the server which the server decrypts with a corresponding public key upon reception of the message, thus validating the identity of the user.

The user authentication data can be provided by means known to a person skilled in the art, e.g. in a form on a user login interface accessed through an Internet browser when connecting to the server or by using an application developed specifically for the backup and restore service.

In response to a positive user authentication the user gains access to the functions of the service and can from there choose to restore computer specific information to a plurality of computers. If several generations of backup copies of computer specific confirmation are present on the server, the user may choose which generation to restore onto which computer of the plurality of computers. Alternatively the restore may start automatically.

The server attempts to establish a communication channel to each computer. Preferably, all data sent over the communication channels are encrypted. Once the communication channels are successfully established the computers are required to authenticate itself for use with the server. This can be accomplished by using the information provided during the registration of the computer or using a private-public key pair. Upon successful authentication of each of the computers the server sends, via the established communication channels, restore initiation requests to the computers 740. Upon receiving these requests, the computers begins to receive their respective computer specific information that has been previously backed up 750.

The received backed up computer specific information is preferably encrypted when sent from the server. The computers processes and decrypts the computer specific information locally in their internal memories. The internal memories may for example be a harddrive, a solid state memory or a volatile memory.

After the computer specific information has been restored to the proper locations, all traces of the computer specific information are deleted from the internal memories of each computer. Thus, no traces of the restore process are left on the computers.

The server and computers may also verify the received computer specific information using methods known to a person skilled in the art, e.g. checksums.

After each successful restore of a computer a confirmation 760 can be sent from each restored computer to the server. The server may confirm that the restore has been performed sending a confirmation 770 to the user. This confirmation can be sent either to the device used for sending the user authentication data or as a mail, SMS or other electronic message to the registered user. Also, the event can be logged by the server.

1. Method for performing backup of computer specific information from a computer comprising:
receiving, at a remote server, user authentication data obtainable from a user of the computer;
in response to a positive authentication based on the user authentication data, the remote server establishing a communication channel between the computer and the remote server;
authenticating, via the communication channel, the computer for use with the server;
sending, via the communication channel, a computer specific information collect request from the server to the computer;
collecting computer specific information at the computer;
encrypting the computer specific information; and
sending, via the communication channel, the encrypted computer specific information to the remote server.

2. The method according to claim 1, wherein the server sends an acknowledgement to the user when the computer specific information has been received by the remote server.

3. The method according to claim 1 , wherein in response to the computer specific information collect request the computer requesting a confirmation from the user.

4. The method according to claim 3, wherein the confirmation is encrypted by a private encryption key.

5. The method according to claim 4, wherein the confirmation comprises user authentication data for the computer.

6. The method according to claim 1, wherein the authenticating of the computer for use with the server comprises the computer sending a message encrypted with a private key and the remote server decrypting the message with a corresponding public key.

7. The method according to claim 1, wherein the computer authenticates the remote server.

8. The method according to claim 7, wherein the authenticating of the remote server comprises the server sending a message encrypted with a private key and the computer decrypting the message with a corresponding public key.

9. The method according to claim 1, wherein the collecting and encrypting of the user data is performed in an internal memory of the computer.

10. The method according to claim 9, wherein the internal memory is a solid state memory.

11. The method according to claim 9, wherein the internal memory is a volatile memory.

12. The method according to claim 9, wherein the computer specific information is deleted from the internal memory after the computer specific information has been sent to the remote server.

13. The method for restoring computer specific information to a computer comprising:
receiving, at a remote server, user authentication data obtainable from a user of the computer;
in response to a positive authentication based on the user authentication data, the remote server establishing a communication channel between the computer and the remote server;
authenticating, via the communication channel, the computer for use with the server;
sending, via the communication channel, a computer specific information restore initiation request from the server to the computer;
sending, via the communication channel, encrypted computer specific information to the computer;
decrypting the computer specific information at the computer; and restoring the computer specific information to the computer.

14. The method according to claim 13, wherein the computer sends an acknowledgement to the user when the computer specific information has been received by the computer.

15. The method according to claim 13, wherein in response to the computer specific information collect request the computer requesting a confirmation from the user.

16. The method according to claim 15, wherein the confirmation is encrypted by means of a private encryption key.

17. The method according to claim 13, wherein the authenticating of the computer for use with the server comprises the computer sending a message encrypted with a private key and the remote server decrypting the message with a corresponding public key.

18. The method according to claim 13, wherein the computer authenticates the remote server.

19. The method according to claim 18, wherein the authenticating of the remote server comprises the server sending a message encrypted with a private key, and the computer decrypting the message with a corresponding public key.

20. The method according to claim 13, wherein the decrypting of the computer specific information is performed in an internal memory.

21. The method according to claim 20, wherein the internal memory is a solid state memory.

22. The method according to claim 20, wherein the internal memory is a volatile memory.

23. The method according to claim 20, wherein the computer specific information is deleted from the internal memory after the computer specific information has been restored to the computer.
